(19) United States
(12) Patent Application Publication
(10) Pub. No.: US 2003/0101341 A1
(43) Pub. Date: May 29, 2003

(54) Method and system for protecting data from unauthorized disclosure

(75) Inventors: Edward W. Kettler III, Plano, TX (US); Jerry D. Pollitt, McKinney, TX (US)

Correspondence Address: Baker Botts L.L.P., Suite 600, 2001 Ross Avenue, Dallas, TX, 75201-2980, US

(73) Assignee: Electronic Data Systems Corporation

(21) Appl. No.: 09/996,099

(22) Filed: Nov. 26, 2001

(51) Int. Cl. G06F 15/18

(52) U.S. Cl. 713/162; 713/193

(57) ABSTRACT

According to one embodiment of the invention, a computerized method for managing a plurality of data protection rules includes receiving and storing the data protection rules in a database, receiving and storing a plurality of permissions generated by a data owner in the database, accepting a query from a data requester with respect to a particular set of data, accessing the database to validate that a permission exists for the data requester, accessing the database to validate that the particular set of data may be accessed by the data requester, and generating a response to the query.

### TECHNICAL FIELD OF THE INVENTION

The present invention relates generally to the field of data protection and, more particularly, to a method and system for protecting data from unauthorized disclosure.

### BACKGROUND OF THE INVENTION

An increasing quantity of legislation regarding data protection and privacy has emerged globally in recent years as a result of an increasing use of computer networks, such as intranets, extranets, and the internet. The various rules, regulations, and laws are not standardized on either a global, regional, or country basis, which results in many conflicts regarding the capture and use of personal and business data.

Corporations, especially large ones that have operations in multiple countries, have to deal with varying degrees of data protection requirements. For example, some countries have very little data protection requirements, and some countries have a myriad of data protection requirements. Consequently, the cost of managing and enforcing the requirements by modifying corporate data processing systems is enormous.

### SUMMARY OF THE INVENTION

According to one embodiment of the invention, a computerized method for managing a plurality of data protection rules includes receiving and storing the data protection rules in a database, receiving and storing a plurality of permissions generated by a data owner in the database, accepting a query from a data requester with respect to a particular set of data, accessing the database to validate that a permission exists for the data requester, accessing the database to validate that the particular set of data may be accessed by the data requester, and generating a response to the query.

According to another embodiment of the invention, a computerized method for managing a plurality of data protection rules includes receiving and storing the data protection rules and a plurality of corporate policies in a database, querying a user about a user preference with respect to one or more data protection rules stored in the database, accepting the user preference, and storing the user preference in the database.

According to another embodiment of the invention, a computerized method for managing a plurality of data protection rules includes receiving and storing a first set of data protection rules, receiving a second set of data protection rules, comparing the second set of data protection rules to the first set of data protection rules to determine an impact on existing information, notifying a data owner of the impact, and updating the database with the second set of data protection rules.

According to another embodiment of the invention, a computerized method for managing a plurality of data protection rules includes receiving and storing the data protection rules in a database, receiving and storing one or more states of an entity in the database, receiving a state change of the entity, comparing the state change to the data protection rules stored in the database, determining whether the state change complies with the data protection rules, and updating the database with the state change.

According to another embodiment of the invention, a computerized method for managing a plurality of data protection rules includes receiving and storing a first set of data protection rules in a data protection database, receiving and storing managed system information in a managed system database, extracting meta data from the managed system database and storing the meta data in the data protection database. The meta data is associated with the managed system information. The method further includes receiving a second set of data protection rules, comparing, by utilizing the meta data, the second set of data protection rules to the managed system information to determine if the managed system information complies with the second set of data protection rules, notifying a data owner of one or more results of the comparison, and updating the data protection database with the second set of data protection rules.

Embodiments of the invention provide a number of technical advantages. Embodiments of the invention may include all, some, or none of these advantages. For example, some embodiments significantly decrease the risk of unauthorized disclosure of employee data. Having a Global Data Protection Repository that spans all layers of an enterprise architecture provides consistent application of data protection protocols across the enterprise. In addition, a Global Data Protection Repository centralizes the collection, maintenance, and administration of rules and regulations, and may reduce the number of system modifications to support a corporation. Auditing of managed systems may also be accomplished more easily and cost-effectively. Capturing employee acknowledgements of corporate policies and employee preferences with regard to opting in or opting out of a particular disclosure of his or her personal information is also much easier to accomplish and maintain.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a functional block diagram illustrating an enterprise architecture having a global data protection repository according to one embodiment of the present invention;

FIG. 2 is a block diagram illustrating the global data protection repository of FIG. 1;

FIG. 3 is a flowchart illustrating a data protection authorization method according to one embodiment of the present invention;

FIG. 4 is a flowchart illustrating a method for capturing a users acknowledgement of corporate policies and preferences with respect to certain data protection laws according to one embodiment of the present invention;

FIG. 5 is a flowchart illustrating a method for capturing data protection rules and determining impacts of those data protection rules according to one embodiment of the present invention;

FIG. 6 is a flowchart illustrating a method of capturing and processing a state change according to one embodiment of the present invention;

FIG. 7A is a flowchart illustrating a method of auditing the compliance of a managed system based on new data protection rules according to one embodiment of the present invention; and

FIG. 7B is a flowchart illustrating a method of auditing the compliance of a managed system based on new managed system information according to one embodiment of the present invention.

### DETAILED DESCRIPTION OF EXAMPLE EMBODIMENTS OF THE INVENTION

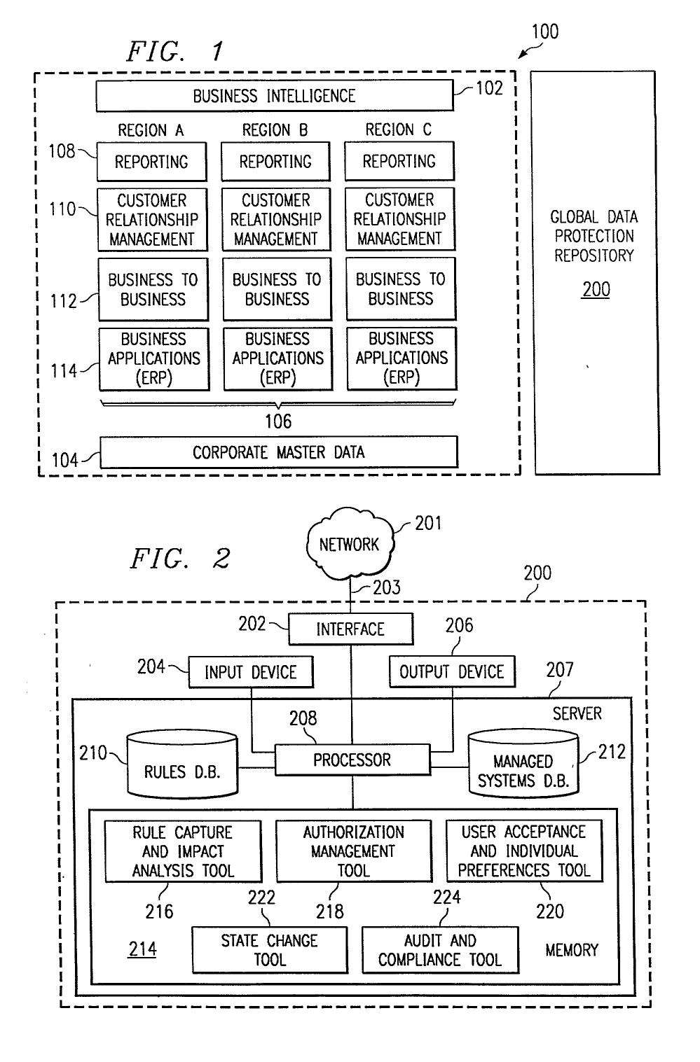

Example embodiments of the present invention and their advantages are best understood by referring now to FIGS. 1 through 7B of the drawings, in which like numerals refer to like parts.

FIG. 1 is a functional diagram illustrating an enterprise architecture 100 having an associated global data protection repository 200 according to one embodiment of the present invention. Enterprise architecture 100 is a functional diagram of a typical large, global corporation. However, enterprise architecture 100 may represent a corporation of any size. As illustrated in FIG. 1, enterprise architecture 100 includes a business intelligence function 102, a corporate master data function 104, and three regions 106, each region 106 including a reporting function 108, a customer relationship management function 110, a business-to-business function 112, and a business applications function 114. Enterprise architecture 100 may have more, less, or different functions and/or elements than that shown in FIG. 1.

Business intelligence function 102 includes data warehouses and other corporate data consolidation systems that contain a myriad of information associated with an enterprise, such as employee information. Corporate master data function 104 provides a consistent definition of major business objects, such as client, chart of account, and organization structures. Regions 106 are separate geographical regions, such as the Americas, Europe, and Australia/Southeast Asia. Although three regions 106 are shown in FIG. 1, there may be any number of regions 106 within enterprise architecture 100.

Reporting function 108 contains operational information about an enterprise, such as manufacturing and construction information. Customer relationship management function 110 contains a myriad of information relating to customers and suppliers and the relationship between them and the enterprise. Business-to-business function 112 contains various information relating to buying and selling products and services between businesses and between businesses and customers, such as buying and selling over the Internet. Business applications function 114 contains information on back office systems, such as payroll information, accounting functions, human resources, and material management.

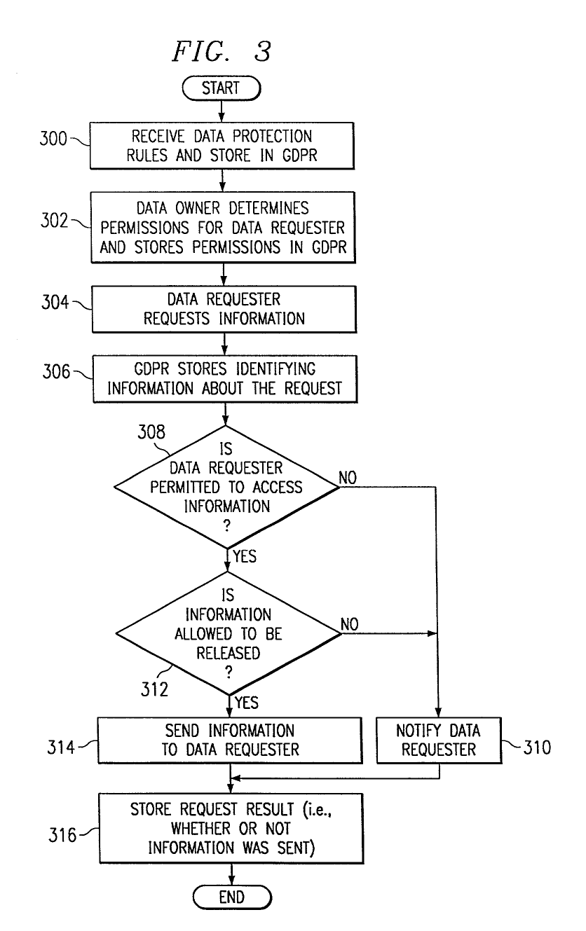

Global data protection repository 200, according to the teachings of the present invention, manages a plurality of data protection rules, as described more fully below in conjunction with FIG. 2. Generally, global data protection repository 200 may function to, among other things, capture, maintain, manage, and enforce one or more data protection laws, regulations, and other rules, for an enterprise, such as an enterprise depicted by enterprise architecture 100. Global data protection repository 200 is communicatively coupled to all functions 102, 104, and 108 through 114 in enterprise architecture 100. For example, as described in more detail below, any of functions 102, 104, and 108 through 114 may have a software application and/or other suitable computer system, whose data protection compliance is managed by global data protection repository 200. This application and/or system is known throughout this detailed description as a managed system. One example of a managed system would be a human resources system, such as Peoplesoft®.

Functions 102, 104, and 108 through 114 and global data protection repository 200 as illustrated in FIG. 1 may comprise a myriad of information in both hard copy and soft copy form. They may also include a myriad of human intelligence, as well as a myriad of computing intelligence, such as computer hardware and/or computer software that is interconnected with any suitable type of communications hardware and/or software. In other words, the functional diagram illustrated in FIG. 1 may comprise one or more networks, such as the Internet, intranets, extranets, and any other suitable networks, or combination thereof, that allows one function to communicate with another function. These networks each may have any number of clients, servers, mainframes, or any other suitable types of computing equipment. In one embodiment, the functionality of functions 102, 104, and 108 through 114 and global data protection repository 100 may all be stored on one large scale mainframe or one large scale server.

FIG. 2 is a block diagram illustrating global data protection repository 200 according to one embodiment of the present invention. Global data protection repository 200, as illustrated, includes an interface 202, an input device 204, an output device 206, and a server 207. Server 207 further includes a processor 208, a rules database 210, a managed systems database 212, and a memory 214. Memory 214 further includes a rule capture and impact analysis tool 216, an authorization management tool 218, a user acceptance and individual preferences tool 220, a state change tool 222, and an audit and compliance tool 224. Although global data protection repository 200 is shown in FIG. 2 to have a single input device 204, a single output device 206, and a single server 207, those skilled in the art understand that the functionality of global data protection repository 200 may be distributed across multiple servers having multiple input devices and multiple output devices.

Interface 202 couples global data protection repository 200 to a network 201 via a link 203. Interface 202 may be any suitable combination of hardware, software, firmware, and/or middleware, operable to facilitate communication between global data protection repository 200 and network 201. For example, interface 202 may be a cable modem, digital subscriber line, 10/100 base-T Ethernet port, fiber optic connection, dial-up connection, or other suitable interface.

Network 201 may be one or more networks, such as an Internet, intranet, extranet, or any other suitable networks or combination thereof. Network 201 represents the functions 102, 104, and 108 through 114 of enterprise architecture 100, as described above. Network 201 may also include employees of an enterprise and may also include information that is not contained in soft copy form. As examples, network 201 may comprise a global computing network, a virtual private network, a local area network, a wide area network, or any other suitable communication network that facilitates communication of data and information between global data protection repository 200 and enterprise architecture 100.

Link 203 may be any suitable wireline connection, such as any conventional telephone line, cable, or fiber optic cable. Link 203 may also be any suitable wireless link.

Input device 204 is coupled to server 207 for the purpose of inputting data and other suitable information. In one embodiment, input device 204 is a client computer; however, input device 204 may be any other suitable device, such as a personal data assistant, a keyboard, a mouse, a stylus, or a scanner. Output device 206 may be any suitable visual display unit, such as a liquid crystal display (“LCD”) or cathode ray tube (“CRT”) display. Output device 206 may also be coupled to other devices, such as a printer (not shown) for the purpose of printing out any desired data or information.

Server 207 is any suitable hardware and/or software having processor 208 that is operable to execute computer programs, such as those tools that are stored in memory 214, which are described in more detail below.

Processor 208 comprises any suitable type of processing unit that executes logic. One of the functions of processor 208 is to execute computer programs that are stored in memory 214. Processor 208 may also control the receiving, storing, and/or retrieving of data, such as data protection rules, from rules database 210 and/or managed systems database 212.

Rules database 210 and managed systems database 212 may be any suitable type of database, such as a relational database, that store information. Rules database 210 and managed system database 212 may comprise files, stacks, or any other suitable organizations of volatile or non-volatile memory. Databases 210, 212 may be random access memory (“RAM”), read only memory (“ROM”), CD-ROM, removable memory devices, or any other suitable devices that allow storage and/or retrieval of data. For example, one function of rules database 210 is to receive and store data protection rules. One function of managed systems database 212 is to receive and store managed systems information, such as payroll information. Databases 210, 212 may be combined into one database or distributed among many databases. There may also be other types of databases in server 207 that perform other functions.

Memory 214 may comprise files, stacks, or other suitable organizations of volatile or non-volatile memory. Memory 214 may be RAM, ROM, CD-ROM, removal of memory devices, or any other suitable devices that allows storage and/or retrieval of data. For example, memory 214 may store tools 216 through 224.

Rule capture and impact analysis tool 216 generally functions to receive existing data protection laws, regulations, and other suitable data protection rules and store them in rules database 210. Tool 216 further functions to receive new and/or updated data protection rules and compare those rules to the existing data protection rules to determine any impacts on existing information associated with enterprise architecture 100. Other functions of tool 216 are described in more detail below.

Authorization management tool 218 generally functions to accept queries from data requesters related to information associated with enterprise architecture 100, access rules database 210 to validate that permissions exist for the data requesters, validate that the desired information may be accessed by the data requesters, and generate a response to the queries. Further details of the functions of tool 218 are described more fully below.

User acceptance and individual preferences tool 220 generally functions to query a user about a user preference with respect to one or more data protection rules, accept one or more user preferences, and store these preferences in rules database 210 or managed systems database 212 or other suitable databases. Tool 220 further functions to query a user about one or more corporate policies and to accept an acknowledgement from the user indicating that the user has agreed to the corporate policies. Additional details on the functions of tool 220 are described in more detail below.

State change tool 222 generally functions to receive a state change of an entity, such as an employee, compare the state change to data protection rules that are stored in rules database 210, determine whether the state change complies with the data protection rules, and update the managed system database 212 with the state change. Further details of tool 222 are described more fully below.

Audit and compliance tool 224 generally functions to extract metadata from managed systems database 212 and store the metadata in rules database 210, receive a new and/or updated set of data protection rules, compare the new and/or updated data protection rules to existing managed systems information stored in managed systems database 212 to determine if the managed systems information complies with the new or updated set of data protection rules. Tool 224 may also function to notify a data owner of one or more results of the comparison and to update rules database 210 with the new and/or updated set of data protection rules. More details on the functions of tool 224 are described more fully below.

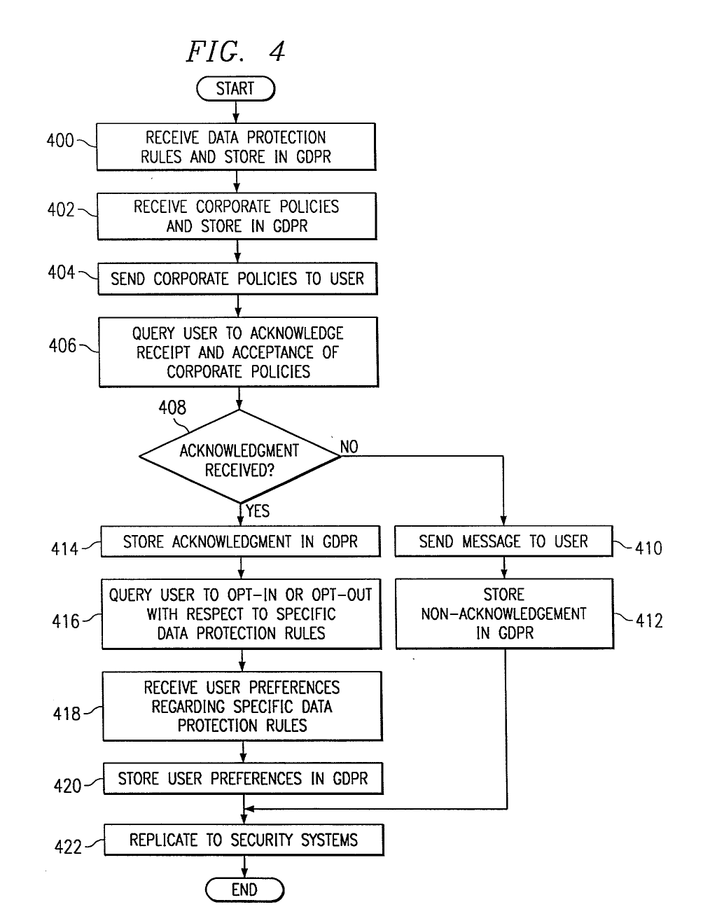

Additional details of some of the functions of tools 216 through 224 according to some embodiments of the present invention are described below in conjunction with FIGS. 3 through 7B.

In operation, global data protection repository 200 functions to capture, maintain, manage, and enforce one or more data protection rules, such as data protection laws, regulations, and other suitable rules for an enterprise, such as the enterprise depicted by enterprise architecture 100 above in FIG. 1. As data protection rules are created and/or revised, one or more employees of an enterprise, such as a business process owner, inputs these data protection rules into global data protection repository 200 so that they may be stored in one or more databases, such as rules database 210. This employee is sometimes referred to in this detailed description as a data owner. Corporate policies with respect to data protection are also input into global data protection repository 200 and stored in either rules database 210 or other suitable database. In addition, managed systems information is stored in managed systems database 212. Although not depicted in FIG. 2, other databases in global data protection repository 200 include information on entities, such as employees, buyers, and suppliers. The data owners keep the data protection rules, corporate policies, and other data protection information constantly updated in rules database 210, managed systems database 212, or other suitable databases.

As described above, global data protection repository 200 has a number of computer software tools that perform various functions related to the data protection rules. For example, if an employee of the enterprise desires to find out certain information on another employee, then authorization management tool 218 receives a query from this user and checks the data protection rules stored in rules database 210 to see if this requesting employee is allowed to see this type of information. Authorization management tool 218 also validates that a permission exists for the requesting employee, which is typically input ahead of time by a data owner or other suitable employee of the enterprise, before allowing a response to be generated to the requesting employee. Permissions are typically determined on an employee-by-employee basis or by the role of an employee and organizational position. Global protection repository 200 may also function to keep track of which employees are receiving which type of information and/or which employees are denied access to certain information.

Global data protection repository 200 may also function to query employees regarding one or more corporate policies relating to data protection. For example, an employee may be queried to read a corporate policy related to some data protection rule and acknowledge that he or she has read and understood the corporate policy by clicking a button to indicate that acknowledgment. Employees may also be prompted to opt in or opt out of specific data protection rules. For example, under certain data protection laws of a certain country, an employee may have the option to allow some of their personal information to be disclosed if that employee elects to opt in. Global data protection repository 200 functions to query this employee and receive the employee's preference with respect to opting in or opting out. If the employee opts-in, then his or her personal information would be stored in global data protection repository 200. Conversely, if the employee opts-out, then his or her personal information is not stored. Then, at a later time, if a requesting employee tries to access that employee's personal information, global data protection repository 200 would first check to see what the data protection rule is for that information. If the rule stated that one cannot see that employee's information unless they opted in, then global data protection repository 200 checks to see whether or not that employee has opted in. If they have, global data protection repository 200 would generate a response to the employee who requested that information.

Global data protection repository 200 may also function to adapt to changes in either data protection rules, corporate policies, or other suitable changes, such as a state change of an employee. For example, if new data protection laws come in for the country of Germany, then global data protection repository 200 compares the new rules to the stored rules in rules database 210 and determines any impacts that those new rules may have. These impacts are then communicated to the appropriate entity in the enterprise, such as the appropriate data owner, so that they may resolve any discrepancies. As another example, if a state change came in for an employee, such as if an employee moves from the United States to Germany, and the new data protection laws in Germany say that this particular employee can opt in with respect to certain personal information, then the global data protection repository 200 is able to prompt that employee that has moved to obtain his or her consent.

Global data protection repository 200 may also function to audit managed systems. For example, based on stored data protection rules and stored managed systems information, an employee may generate reports to find out if the managed systems are complying with the existing data protection rules. Or if a change comes in to a managed system, then global data protection repository 200 may check to see if the new managed system information complies with the existing data protection rules. Other example functions of global data protection repository 200 are described below in conjunction with FIGS. 3 through 7B.

FIG. 3 is a flow chart illustrating a data protection authorization method according to one embodiment of the present invention. This flow chart illustrates example functions of authorization management tool 218. The method begins at step 300 where data protection rules are received and stored in rules database 210 of global data protection repository 200. A data owner, which may be any suitable employee of an enterprise, determines permissions for one or more data requesters and stores these permissions in rules database 210 or another suitable database at step 302. A data requester may also be an employee of an enterprise that is trying to access certain information that may be protected by data protections rules.

At step 304, the data requester requests information. For example, the data requester may be a vice president of an enterprise that wishes to obtain information about an employee, such as an employee's home address, home phone number, or certain payroll information. At step 306, the rules database 210 stores identifying information about the request. For example, rules database 210 may store such information as who is requesting the data (i.e., the data requester), what type of information they are requesting, what time the request was made, and from which location the request was made. At decisional step 308, a determination is made whether the data requester is permitted to access the requested information. If the data requester is not permitted to access that information, then the method proceeds to step 310 as described below. If the data requester is permitted to access that information, then the method proceeds to step 312 where a determination is made whether the requested information is allowed to be released to the data requester. If the information is not allowed to be released to the data requester, such as when that information is protected by certain data protection rules, then the method proceeds to step 310 as outlined below. If the information is allowed to be released to the data requester, then the method proceeds to step 314 where the information is sent to the data requester.

If the data requester is not permitted to access that information or if that information is not allowed to be released to the data requester, then at step 310 the data requester is notified as to the reason why they are not able to access the information and the method proceeds to step 316. At step 316, a request result is stored in rules database 210 or other suitable database in global data protection repository 200. For example, a request result may be whether or not the information was sent to the data requester. This request result may also contain timestamp information or other suitable identifying information as to the request result.

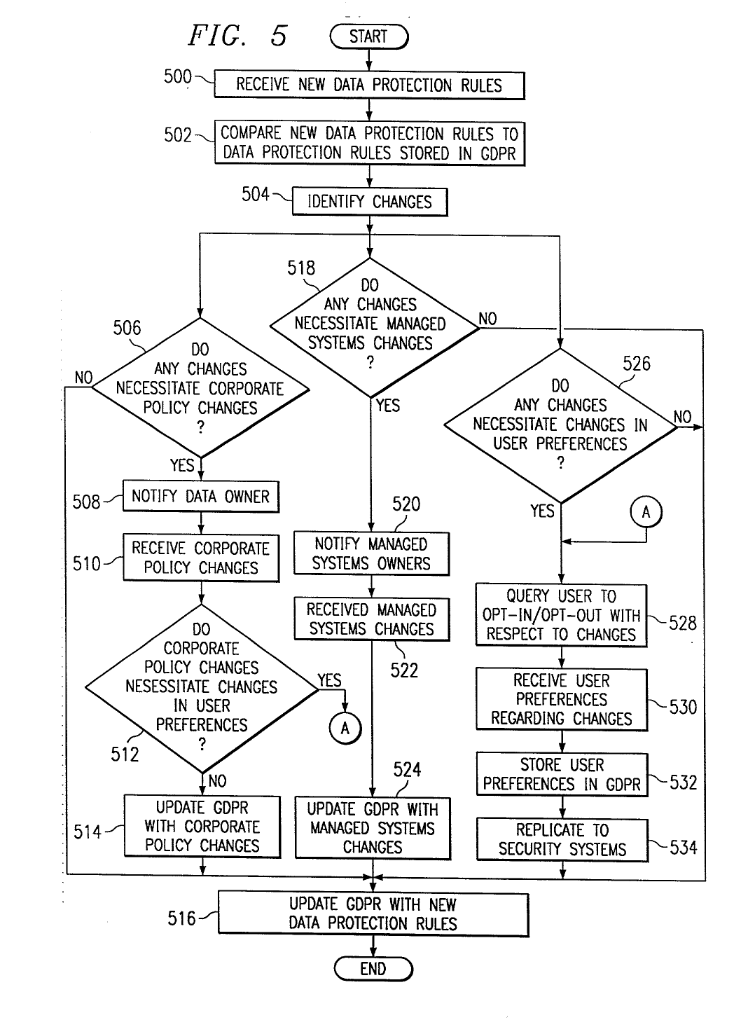

FIG. 4 is a flow chart illustrating a method for capturing a user's acknowledgment of corporate policies and a user's preferences with respect to certain data protection rules according to various embodiments of the present invention. This flow chart illustrates example functions of user acceptance and individual preferences tool 220. The method begins at step 400 where data protection rules are received and stored in rules database 210 in global data protection repository 200. Similarly, at step 402, corporate policies are received and stored in rules database 210 or other suitable database in global data protection repository 200. Corporate policies may supplement or add to existing data protection rules.

At step 404, one or more corporate policies are sent to a user, such as an employee of an enterprise. The user is queried, at step 406, to acknowledge receipt and acceptance of the corporate policies that were sent at step 404. At decisional step 408, a determination is made whether the user's acknowledgment was received. If the user's acknowledgment is not received, then a message is sent to the user at step 410. For example, the message sent to the user may alert the user that his non-acknowledgment has been received and it may explain possible implications of the user's non-acknowledgment. The non-acknowledgment is stored in rules database 210 or other suitable database, at step 412, and the method continues at step 422 as outlined below. If the acknowledgment is received at step 408, the acknowledgment is stored in rules database 210 or other suitable database in global data protection repository 200.

At step 416, a user is queried to opt-in or opt-out of specific data protection rules. For example, if a data protection law in Germany states that certain personal information of an employee may not be disclosed unless an employee agrees to disclose it, then this is a situation where a user would be queried to give him or her a chance to opt-in and allow certain personal information to be disclosed, if so requested. User preferences are received at step 418 regarding specific data protection rules and these user preferences are stored in rules database 210 or other suitable database in global data protection repository 200. User preferences are the decisions made by a user with respect to opting-in or opting-out of certain data protection rules.

At step 422, the user's acknowledgment or non-acknowledgment of certain corporate policies are replicated to a security system database in the enterprise for security purposes. In addition, user preferences with respect to opting-in and/or opting-out of specific data protection rules are also replicated to the security systems. These security systems help the legal department or other suitable departments of an enterprise to keep track of employees' actions and preferences with respect to data protection rules.

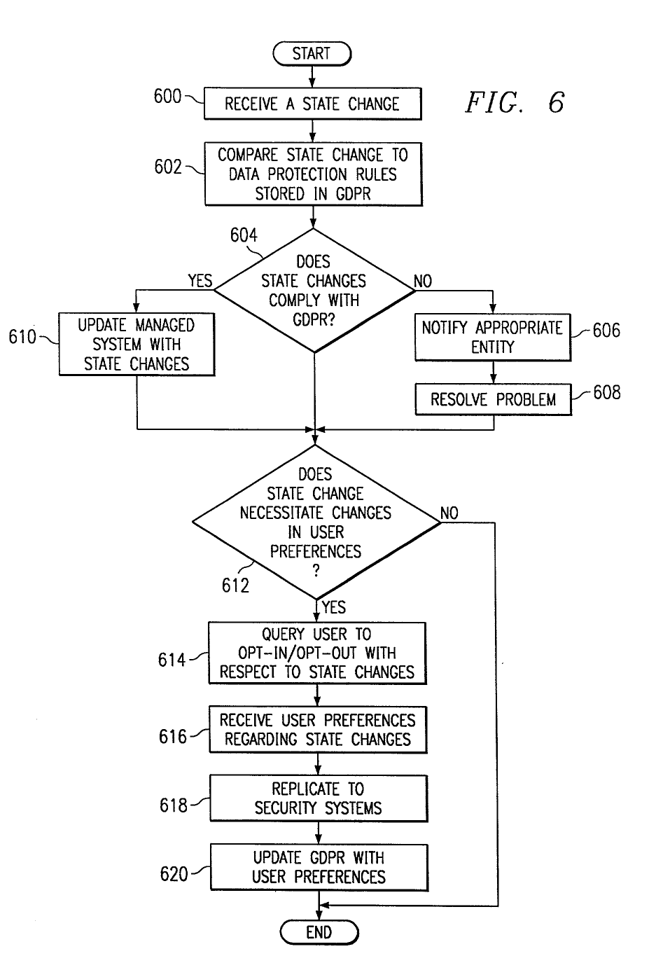

FIG. 5 is a flow chart illustrating a method for capturing data protection rules and determining impacts of those data protection rules according to one embodiment of the present invention. This flow chart illustrates example functions of rule capture and impact analysis tool 216. The method begins at step 500 where new and/or updated data protection rules are received. For example, data protection laws in a specific country may be changed, certain government regulations may be promulgated, or data protection rules may be provided by labor agreements or work council agreements. At step 512, these new data protection rules are compared to existing data protection rules stored in rules database 210 of global data protection repository 200. Any differences and/or changes are identified at step 504.

At decisional step 506, a determination is made whether any changes in data protection rules necessitate any corporate policy changes of an enterprise. If no changes to corporate policies are necessary, then the method proceeds to step 516 as described below. If corporate policy changes are necessitated, then a data owner of corporate policy changes is notified at step 508. For example, a vice president or high-level manager of a corporation may receive an e-mail stating that because of a new data protection law, this particular corporate policy needs to be changed. At that time, there is a change in the corporate policy, and that changed corporate policy is input into global data protection repository 200 at step 510. At decisional step 512, a determination is made whether these new corporate policy changes necessitate changes in user preferences. If no user preference changes are necessary, then the method proceeds to step 514 where the global data protection repository 200 is updated with the new corporate policy changes, which may be stored in rules database 210 or other suitable database. The method would then proceed to step 516 as described below. If changes in user preferences are necessitated by the new corporate policy changes, then the method proceeds to step 528 as described in further detail below.

Referring to decisional step 518, a determination is made whether any data protection rules changes necessitate managed systems changes. If no managed systems changes are necessary, then the method proceeds to step 516 as described below. If managed systems changes are necessary, then the method proceeds to step 520 where a managed systems owner is notified via an e-mail or other suitable communication that manage systems changes are necessary. At this point, a particular managed system may be changed automatically or may be changed manually via employee intervention. For example, a simple change may be handled by rule capture and impact analysis tool 216 or updated managed system software may be received by a supplier to update managed systems database 212.

At step 522, the managed system changes are received and the global data protection repository 200 is updated with the managed systems changes at step 524. For example, any suitable database in global data protection repository 200, such as managed systems database 212, may accept and store these managed systems changes. The method then proceeds to step 516 as described more fully below.

Referring to decisional step 526, a determination is made whether any data protection rules changes necessitate changes in user preferences. If no user preference changes are necessary, then the method then proceeds to step 516 as described more fully below. If, however, changes to user preferences are necessary, then the method proceeds to step 528 where a user is queried with respect to opting-in or opting-out of specific data protection rules that have been updated and/or added. In step 530, the new user preferences are received with respect to opting-in or opting-out and these user preferences are stored at step 532 in global data protection repository 200, such as rules database 210 or other suitable database. These user preferences are replicated to the security system at step 534. The method then proceeds to step 516. At step 516, the global data protection repository 200 is updated with the new or updated data protection rules that were received at step 500.

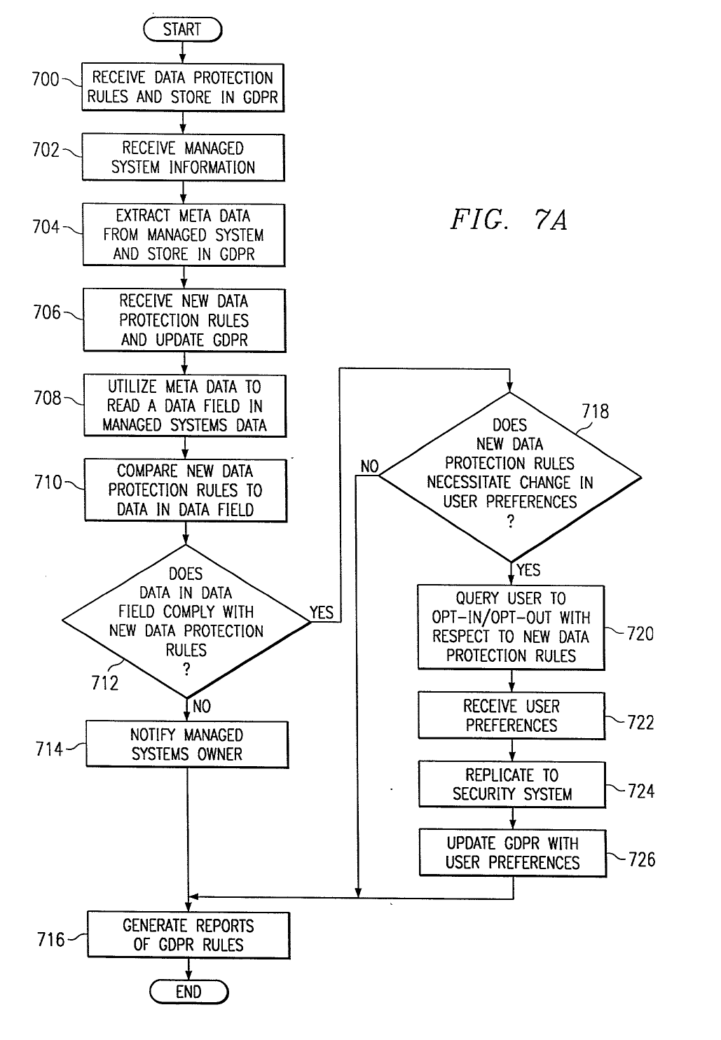

FIG. 6 is a flowchart illustrating a method of capturing and processing a state change according to one embodiment of the present invention. This flow chart illustrates example functions of state change tool 222. The method begins at step 600 where a state change is received. For example, a state change may be where an employee's location changes from the United States to Germany. At step 602, the state change is compared to data protection rules stored in rules database 210 of global data protection repository 200.

At decisional step 604, a determination is made whether the state change complies with the data protection rules stored in rules database 210. If the state change does not comply, then the appropriate entity is notified at step 606 and the problem resolved at step 608. For example, the appropriate entity may be a data owner, such as a business process owner, that has to resolve the problem by deleting certain protected personal information of the employee that has moved from, for example, United States to Germany. The database in this case would have to be updated to reflect and comply with current data protection rules. If the state change does comply with the data protection rules in rules database 210, then any managed systems are updated with the state change at step 610.

At decisional step 612, a determination is made whether the state change necessitates any changes in user preferences with respect to opting-in or opting-out of specific data protection rules. If no changes in user preferences are required, then the method ends. However, if user preference changes are required because of the state change, then the method proceeds to step 614 where the user is queried with respect to opting-in or opting-out of the data protection rule that has been affected by the state change. At step 616, the user preferences with regard to the state change and associated data protection rule is received at step 616. The user preferences are replicated to security systems at step 618. At step 620, global data protection repository 200 is updated with the user preferences, such as by updating rules database 210 or other suitable database.

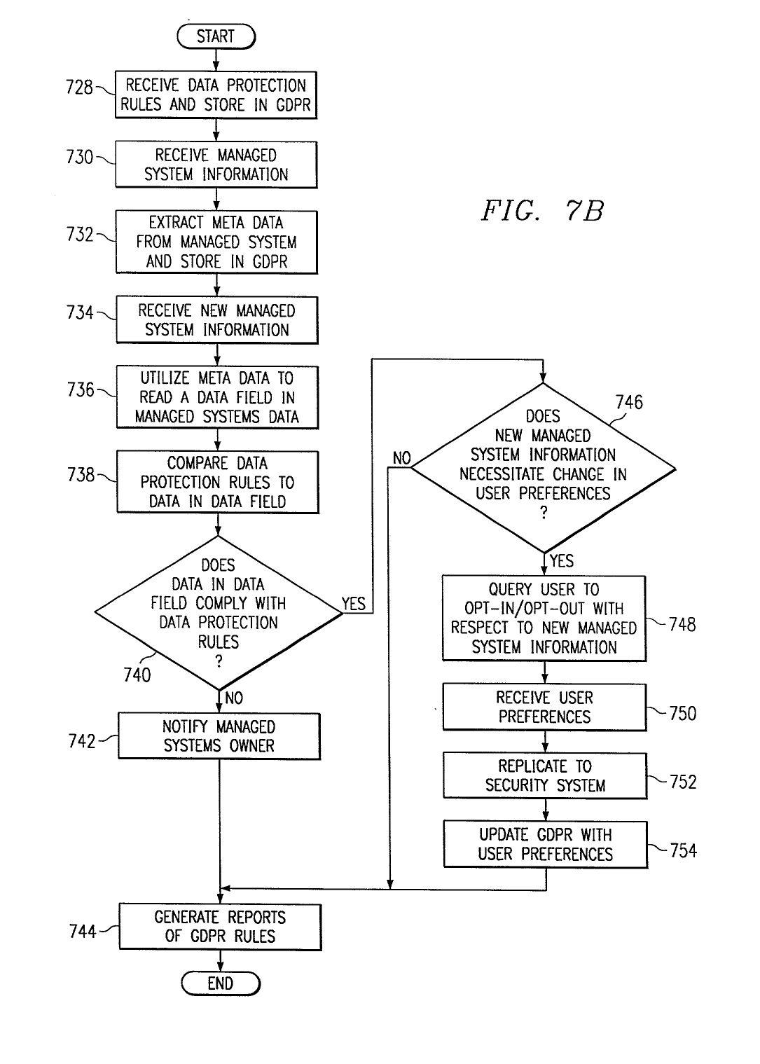

FIG. 7 is a flowchart illustrating a method of auditing one or more data protection rules or managed systems according to one embodiment of the present invention. This flow chart illustrates example functions of audit and compliance tool 224. The method begins at step 700 where data protection rules are received and stored in rules database 210 of global data protection repository 200. In addition, managed system information is received at step 702 and stored in, for example, managed systems database 212. Metadata is extracted from the managed system information stored in managed system database 212 and stored in rules database 210 at step 704. Metadata is information used to define the managed system information stored in managed systems database 212.

At step 706, new or updated data protection rules are received and stored in rules database 210. The metadata is utilized in step 708 to read one or more data fields of managed systems information contained in managed systems database 212. The new or updated data protection rules are compared to the managed system information in the data field(s) at step 710. At decisional step 712, a determination is made whether the data in the data field(s) complies with the new or updated data protection rules. If the managed system data does not comply with the new or updated data protection rules, then a managed systems owner is notified at step 714 via e-mail or other suitable communication, and the method continues at step 716 as described below. If the managed system data complies with the new or updated data protection rules at step 712, then the method proceeds to decisional step 718 where a determination is made whether the new or updated data protection rules necessitate a change in user preferences. If no changes in user preferences are required, then the method continues at step 716 as described below. However, if user preferences changes are required, then the method proceeds to step 720 where a user is queried to opt-in or opt-out with respect to the new or updated data protection rules. The revised or new user preferences are received at step 722 and replicated to security systems at step 724. Global data protection repository 200 is updated with user preferences at step 726, such as by storing the user preferences in rules database 210 or other suitable database. The method then proceeds to step 716.

At step 716, reports of one or more data protection rules are generated. For example, if an officer of the corporation needs or wants to take a look at certain data protection rules for certain regions 106, employees, or certain subsidiaries of the corporation then step 716 generates the report and typically uses output device 206 to present a hard copy of that report. Other suitable reports may be generated, such as information regarding managed systems changes.

FIG. 7B is a flowchart illustrating a method of auditing the compliance of a managed system based on new managed system information according to one embodiment of the present invention. This flow chart illustrates example functions of audit and compliance tool 224. The method begins at step 728 where data protection rules are received and stored in rules database 210. Managed system information is also received at step 730. As described above, metadata from managed system information is extracted at step 732 and stored in rules database 210 or other suitable database.

New and/or updated managed system information is received at step 734. Metadata is utilized at step 736 to read one or more data fields in managed system information stored in managed systems database 212. Data protection rules are compared to managed systems information in the particular data field(s). At decisional step 740, a determination is made whether managed system information in the data field(s) complies with the data protection rules. If the managed systems information stored in managed systems database 212 does not comply with the data protection rules, then a managed systems owner is notified at step 742 via e-mail or other suitable communication, so that the managed systems owner may address the non-compliance. The method then proceeds to step 744 as described below.

If the managed systems information in managed systems database 212 complies with the data protection rules, then the method proceeds to decisional step 746 where a determination is made whether the new and/or updated managed system information necessitates a change in user preferences. If no change in user preferences are required, then the method proceeds to step 744 as described below. However, if a change in user preferences are necessitated by the new and/or updated managed system information, then the method proceeds to step 748 where a user is queried to opt-in or opt-out with respect to the new and/or updated managed system information. User preferences are received at step 750 and replicated to security systems at step 752. Global data protection repository 200 is updated with the new and/or revised user preferences at step 754 before the method continues at step 744.

At step 744, reports of one or more data protection rules are generated. For example, if an officer of the corporation needs or wants to take a look at certain data protection rules for certain regions 106, employees, or certain subsidiaries of the corporation then step 744 generates the report and typically uses output device 206 to present a hard copy of that report. Other suitable reports may be generated, such as information regarding managed systems changes or user preference changes.

Although embodiments of the invention and their advantages are described in detail, a person skilled in the art could make various alterations, additions, and omissions without departing from the spirit and scope of the present invention as defined by the appended claims.

What is claimed is:

1. A system for managing a plurality of data protection rules, comprising:
a processor;
a database coupled to the processor, the database operable to receive and store the data protection rules and to receive and store a plurality of permissions generated by a data owner;
a memory coupled to the processor;
an authorization management tool residing in the memory and executable by the processor, the authorization management tool operable to:
accept a query from a data requester, the query related to a particular set of data;
access the database to validate that a permission exists for the data requester;
access the data protection rules in the database to validate that the particular set of data may be accessed by the data requester; and
generate a response to the query.

2. The system of claim 1, wherein the authorization management tool is further operable to store identifying information about the data requester in the database.

3. The system of claim 1, wherein the authorization management tool is further operable to store a query result in the database, the query result related to whether the response was generated.

4. The system of claim 1, further comprising a user acceptance tool residing in the memory and executable by the processor, the user acceptance tool operable to:
query a user about a user preference with respect to the data protection rules;
accept the user preference; and
store the user preference in the database.

5. The system of claim 4, wherein the authorization management tool is further operable to access the user preferences in the database to validate that the particular set of data may be accessed by the data requester.

6. The system of claim 1, further comprising a state change tool residing in the memory and executable by the processor, the state change tool operable to:
receive a state change of an entity;
compare the state change to the data protection rules stored in the database;
determine whether the state change complies with the data protection rules; and
update the database with the state change.

7. The system of claim 6, wherein the entity is a user and the state change tool is further operable to:
query the user about a user preference with respect to the data protection rules;
accept the user preference; and
store the user preference in the database.

8. The system of claim 7, wherein the authorization management tool is further operable to access the user preferences in the database to validate that the particular set of data may be accessed by the data requester.

9. The system of claim 1, wherein the authorization management tool is further operable to access one or more corporate policies in the database to validate that the particular set of data may be accessed by the data requester.

10. A computerized method for managing a plurality of data protection rules, comprising:
receiving and storing the data protection rules in a database;
receiving and storing a plurality of permissions generated by a data owner in the database;
accepting a query from a data requester, the query related to a particular set of data;
accessing the database to validate that a permission exists for the data requester;
accessing the database to validate that the particular set of data may be accessed by the data requester; and
generating a response to the query.

11. The computerized method of claim 10, further comprising storing identifying information about the data requester in the database.

12. The computerized method of claim 10, further comprising storing a query result in the database, the query result related to whether the response was generated.

13. The computerized method of claim 10, further comprising:
querying a user about a user preference with respect to the data protection rules;
accepting the user preference; and
storing the user preference in the database.

14. The computerized method of claim 13, further comprising accessing the user preferences in the database to validate that the particular set of data may be accessed by the data requester.

15. The computerized method of claim 10, further comprising:
receiving a state change of an entity;
comparing the state change to the data protection rules stored in the database;
determining whether the state change complies with the data protection rules; and
updating the database with the state change.

16. The computerized method of claim 15, further comprising:
querying the user about a user preference with respect to the data protection rules;
accepting the user preference; and
storing the user preference in the database.

17. The computerized method of claim 16, further comprising accessing the user preferences in the database to validate that the particular set of data may be accessed by the data requester.

18. The computerized method of claim 10, further comprising accessing one or more corporate policies stored in the database to validate that the particular set of data may be accessed by the data requester.

19. A system for managing a plurality of data protection rules, comprising:
a processor;
a database coupled to the processor, the database operable to receive and store the data protection rules and a plurality of corporate policies;
a memory coupled to the processor;
a user acceptance tool residing in the memory and executable by the processor, the user acceptance tool operable to:
query a user about a user preference with respect to one or more data protection rules stored in the database;
accept the user preference; and
store the user preference in the database.

20. The system of claim 19, wherein the user acceptance tool is further operable to:
query a user about one or more corporate policies; and
accept an acknowledgement from the user, the acknowledgement indicating that the user has agreed to the corporate policies.

21. The system of claim 20, wherein the user acceptance tool is further operable to send the acknowledgement to a security system database.

22. The system of claim 19, further comprising an authorization management tool residing in the memory and executable by the processor, the authorization management tool operable to:
accept a query from a data requester, the query related to a particular set of data;
access the database to validate that a permission exists for the data requester;
access the data protection rules, the corporate policies, and the user preferences in the database to validate that the particular set of data may be accessed by the data requester; and
generate a response to the query.

23. The system of claim 22, wherein the authorization management tool is further operable to store identifying information about the data requester in the database.

24. The system of claim 22, wherein the authorization management tool is further operable to store a query result in the database, the query result related to whether the response was generated.

25. The system of claim 19, further comprising a state change tool residing in the memory and executable by the processor, the state change tool operable to:
receive a state change of the user;
compare the state change to the data protection rules, the corporate policies, and the user preferences stored in the database;
determine whether the state change complies with the data protection rules, the corporate policies, and the user preferences; and
update the database with the state change.

26. The system of claim 25, wherein the state change tool is further operable to:
query, based on the state change, the user about a new user preference with respect to the data protection rules;
accept the new user preference; and
update the database with the new user preference.

27. A computerized method for managing a plurality of data protection rules, comprising:
receiving and storing the data protection rules and a plurality of corporate policies in a database;
querying a user about a user preference with respect to one or more data protection rules stored in the database;
accepting the user preference; and
storing the user preference in the database.

28. The computerized method of claim 27, further comprising:
querying a user about one or more corporate policies; and
accepting an acknowledgement from the user, the acknowledgement indicating that the user has agreed to the corporate policies.

29. The computerized method of claim 28, further comprising sending the acknowledgement to a security computerized method database.

30. The computerized method of claim 27, further comprising:
accepting a query from a data requester, the query related to a particular set of data;
accessing the database to validate that a permission exists for the data requester;
accessing the data protection rules, the corporate policies, and the user preferences in the database to validate that the particular set of data may be accessed by the data requester; and
generating a response to the query.

31. The computerized method of claim 30, further comprising storing identifying information about the data requester in the database.

32. The computerized method of claim 30, further comprising storing a query result in the database, the query result related to whether the response was generated.

33. The computerized method of claim 27, further comprising:
receiving a state change of the user;
comparing the state change to the data protection rules, the corporate policies, and the user preferences stored in the database;
determining whether the state change complies with the data protection rules, the corporate policies, and the user preferences; and
updating the database with the state change.

34. The computerized method of claim 33, further comprising:
querying, based on the state change, the user about a new user preference with respect to the data protection rules;
accepting the new user preference; and
updating the database with the new user preference.

35. A system for managing a plurality of data protection rules, comprising:
a processor;
a database coupled to the processor, the database operable to receive and store a first set of data protection rules;
a memory coupled to the processor;
an impact analysis tool residing in the memory and executable by the processor, the impact analysis tool operable to:
receive a second set of data protection rules;
compare the second set of data protection rules to the first set of data protection rules to determine an impact on existing information;
notify a data owner of the impact; and
update the database with the second set of data protection rules.

36. The system of claim 35, wherein the existing information is one or more corporate policies.

37. The system of claim 36, wherein the impact analysis tool is further operable to receive one or more revised corporate policies, and update the database with the corporate policies.

38. The system of claim 35, wherein the existing information is one or more managed systems.

39. The system of claim 38, wherein the impact analysis tool is further operable to receive a revised managed system, and update the database with the managed system.

40. The system of claim 35, wherein the existing information is one or more user preferences associated with one or more of the second set of data protection rules.

41. The system of claim 40, wherein the impact analysis tool is further operable to:
query a user about the user preferences;
accept the user preference; and
update the database with the user preferences.

42. The system of claim 35, further comprising an authorization management tool residing in the memory and executable by the processor, the authorization management tool operable to:
accept a query from a data requester, the query related to a particular set of data;
access the database to validate that a permission exists for the data requester;
access the second set of data protection rules in the database to validate that the particular set of data may be accessed by the data requester; and
generate a response to the query.

43. The system of claim 42, wherein the authorization management tool is further operable to store identifying information about the data requester in the database.

44. The system of claim 42, wherein the authorization management tool is further operable to store a query result in the database, the query result related to whether the response was generated.

45. The system of claim 41, further comprising a state change tool residing in the memory and executable by the processor, the state change tool operable to:
receive a state change of the user;
compare the state change to the second set of data protection rules and the user preferences stored in the database;
determine whether the state change complies with the second set of data protection rules and the user preferences; and
update the database with the state change.

46. A computerized method for managing a plurality of data protection rules, comprising:
receiving and storing a first set of data protection rules;
receiving a second set of data protection rules;
comparing the second set of data protection rules to the first set of data protection rules to determine an impact on existing information;
notifying a data owner of the impact; and
updating the database with the second set of data protection rules.

47. The computerized method of claim 46, wherein the existing information is one or more corporate policies.

48. The computerized method of claim 47, further comprising receiving one or more revised corporate policies and updating the database with the corporate policies.

49. The computerized method of claim 46, wherein the existing information is one or more managed systems.

50. The computerized method of claim 49, further comprising receiving a revised managed system and updating the database with the managed system.

51. The computerized method of claim 46, wherein the existing information is one or more user preferences associated with one or more of the second set of data protection rules.

52. The computerized method of claim 51, further comprising:
querying a user about the user preferences;
accepting the user preference; and
updating the database with the user preferences.

53. The computerized method of claim 46, further comprising:
accepting a query from a data requester, the query related to a particular set of data;
accessing the database to validate that a permission exists for the data requester;
accessing the second set of data protection rules in the database to validate that the particular set of data may be accessed by the data requester; and
generating a response to the query.

54. The computerized method of claim 53, further comprising storing identifying information about the data requester in the database.

55. The computerized method of claim 53, further comprising storing a query result in the database, the query result related to whether the response was generated.

56. The computerized method of claim 52, further comprising:
receiving a state change of the user;
comparing the state change to the second set of data protection rules and the user preferences stored in the database;
determining whether the state change complies with the second set of data protection rules and the user preferences; and
updating the database with the state change.

57. A system for managing a plurality of data protection rules, comprising:
a processor;
a database coupled to the processor, the database operable to receive and store the data protection rules and to receive and store one or more states of an entity;
a memory coupled to the processor;
a state change tool residing in the memory and executable by the processor, the state change tool operable to:
receive a state change of the entity;
compare the state change to the data protection rules stored in the database;
determine whether the state change complies with the data protection rules; and
update the database with the state change.

58. The system of claim 57, wherein the state change tool is further operable to notify a data owner of the state change.

59. The system of claim 57, further comprising an authorization management tool residing in the memory and executable by the processor, the authorization management tool operable to:
accept a query from a data requester, the query related to a particular set of data;
access the database to validate that a permission exists for the data requester;
access the data protection rules in the database to validate that the particular set of data may be accessed by the data requester; and
generate a response to the query.

60. The system of claim 59, wherein the authorization management tool is further operable to store identifying information about the data requester in the database.

61. The system of claim 59, wherein the authorization management tool is further operable to store a query result in the database, the query result related to whether the response was generated.

62. The system of claim 59, further comprising a user acceptance tool residing in the memory and executable by the processor, the user acceptance tool operable to:
query a user about a user preference with respect to the data protection rules;
accept the user preference; and
store the user preference in the database.

63. The system of claim 62, wherein the authorization management tool is further operable to access the user preferences in the database to validate that the particular set of data may be accessed by the data requester.

64. A computerized method for managing a plurality of data protection rules, comprising:
receiving and storing the data protection rules in a database;
receiving and storing one or more states of an entity in the database;
receiving a state change of the entity;
comparing the state change to the data protection rules stored in the database;
determining whether the state change complies with the data protection rules; and
updating the database with the state change.

65. The computerized method of claim 64, further comprising notifying a data owner of the state change.

66. The computerized method of claim 64, further comprising:
accepting a query from a data requester, the query related to a particular set of data;
accessing the database to validate that a permission exists for the data requester;
accessing the data protection rules in the database to validate that the particular set of data may be accessed by the data requester; and
generating a response to the query.

67. The computerized method of claim 66, further comprising storing identifying information about the data requester in the database.

68. The computerized method of claim 66, further comprising storing a query result in the database, the query result related to whether the response was generated.

69. The computerized method of claim 66, further comprising:
querying a user about a user preference with respect to the data protection rules;
accepting the user preference; and
storing the user preference in the database.

70. The computerized method of claim 69, further comprising accessing the user preferences in the database to validate that the particular set of data may be accessed by the data requester.

71. A system for managing a plurality of data protection rules, comprising:
a processor;
a data protection database coupled to the processor, the data protection database operable to receive and store a first set of data protection rules;
a managed system database coupled to the processor, the managed system database operable to receive and store managed system information;
a memory coupled to the processor;
an audit and compliance tool residing in the memory and executable by the processor, the audit and compliance tool operable to:
extract meta data from the managed system database and store the meta data in the data protection database, the meta data associated with the managed system information;
receive a second set of data protection rules;
compare, by utilizing the meta data, the second set of data protection rules to the managed system information to determine if the managed system information complies with the second set of data protection rules;
notify a data owner of one or more results of the comparison; and
update the data protection database with the second set of data protection rules.

72. The system of claim 71, wherein the audit and compliance tool is further operable to generate a report of the first and second data protection rules.

73. The system of claim 71, further comprising an impact analysis tool residing in the memory and executable by the processor, the impact analysis tool operable to:
receive the second set of data protection rules;
compare the second set of data protection rules to the first set of data protection rules to determine an impact on existing information;
notify a data owner of the impact; and
update the data protection database with the second set of data protection rules.

74. The system of claim 73, wherein the existing information is one or more corporate policies.

75. The system of claim 74, wherein the impact analysis tool is further operable to receive one or more revised corporate policies, and update the data protection database with the corporate policies.

76. The system of claim 73, wherein the existing information is one or more user preferences associated with one or more of the second set of data protection rules.

77. The system of claim 76, wherein the impact analysis tool is further operable to:
query a user about the user preferences;
accept the user preference; and
update the data protection database with the user preferences.

78. The system of claim 71, further comprising an authorization management tool residing in the memory and executable by the processor, the authorization management tool operable to:
accept a query from a data requester, the query related to a particular set of data;
access the managed system database to validate that a permission exists for the data requester;
access the second set of data protection rules in the data protection database to validate that the particular set of data may be accessed by the data requester; and
generate a response to the query.

79. The system of claim 78, wherein the authorization management tool is further operable to store identifying information about the data requester in the managed system database.

80. The system of claim 78, wherein the authorization management tool is further operable to store a query result in the managed system database, the query result related to whether the response was generated.

81. The system of claim 77, further comprising a state change tool residing in the memory and executable by the processor, the state change tool operable to:
receive a state change of a user;
compare the state change to the second set of data protection rules and the user preferences stored in the data protection database;
determine whether the state change complies with the second set of data protection rules and the user preferences; and
update the managed system database with the state change.

82. A computerized method for managing a plurality of data protection rules, comprising:
receiving and storing a first set of data protection rules in a data protection database;
receiving and storing managed system information in a managed system database;
extracting meta data from the managed system database and storing the meta data in the data protection database, the meta data associated with the managed system information;
receiving a second set of data protection rules;
comparing, by utilizing the meta data, the second set of data protection rules to the managed system information to determine if the managed system information complies with the second set of data protection rules;
notifying a data owner of one or more results of the comparison; and
updating the data protection database with the second set of data protection rules.

83. The computerized method of claim 82, further comprising generating a report of the first and second data protection rules.

84. The computerized method of claim 82, further comprising:
receiving the second set of data protection rules;
comparing the second set of data protection rules to the first set of data protection rules to determine an impact on existing information;
notifying a data owner of the impact; and
updating the data protection database with the second set of data protection rules.

85. The computerized method of claim 84, wherein the existing information is one or more corporate policies.

86. The computerized method of claim 85, further comprising receiving one or more revised corporate policies and updating the data protection database with the corporate policies.

87. The computerized method of claim 84, wherein the existing information is one or more user preferences associated with one or more of the second set of data protection rules.

88. The computerized method of claim 87, further comprising:
querying a user about the user preferences;
accepting the user preference; and
updating the data protection database with the user preferences.

89. The computerized method of claim 82, further comprising:
accepting a query from a data requester, the query related to a particular set of data;
accessing the managed system database to validate that a permission exists for the data requester;
accessing the second set of data protection rules in the data protection database to validate that the particular set of data may be accessed by the data requester; and
generating a response to the query.

90. The computerized method of claim 89, further comprising storing identifying information about the data requester in the database.

91. The computerized method of claim 89, further comprising storing a query result in the managed system database, the query result related to whether the response was generated.

92. The computerized method of claim 88, further comprising:
receiving a state change of a user;
comparing the state change to the second set of data protection rules and the user preferences stored in the data protection database;
determining whether the state change complies with the second set of data protection rules and the user preferences; and
updating the managed system database with the state change.

93. A system for managing a plurality of data protection rules, comprising:
a processor;
a data protection database coupled to the processor, the data protection database operable to receive and store the data protection rules;
a managed system database coupled to the processor, the managed system database operable to receive and store a first set of managed system information;
a memory coupled to the processor;
an audit and compliance tool residing in the memory and executable by the processor, the audit and compliance tool operable to:
extract meta data from the managed system database and store the meta data in the data protection database, the meta data associated with the first set of managed system information;
receive a second set of managed system information;
compare, by utilizing the meta data, the data protection rules to the second set of managed system information to determine if the second set of managed system information complies with the data protection rules;
notify a data owner of one or more results of the comparison; and
update the managed system database with the second set of managed system information.

94. The system of claim 93, wherein the audit and compliance tool is further operable to generate a report of the data protection rules.

95. The system of claim 93, further comprising an impact analysis tool residing in the memory and executable by the processor, the impact analysis tool operable to:
receive the second set of data protection rules;
compare the second set of data protection rules to the first set of data protection rules to determine an impact on existing information;
notify a data owner of the impact; and
update the data protection database with the second set of data protection rules.

96. The system of claim 95, wherein the existing information is one or more corporate policies.

97. The system of claim 96, wherein the impact analysis tool is further operable to receive one or more revised corporate policies, and update the data protection database with the corporate policies.

98. The system of claim 95, wherein the existing information is one or more user preferences associated with one or more of the second set of data protection rules.

99. The system of claim 98, wherein the impact analysis tool is further operable to:
query a user about the user preferences;
accept the user preference; and
update the data protection database with the user preferences.

100. The system of claim 93, further comprising an authorization management tool residing in the memory and executable by the processor, the authorization management tool operable to:
accept a query from a data requester, the query related to a particular set of data;
access the managed system database to validate that a permission exists for the data requester;
access the second set of data protection rules in the data protection database to validate that the particular set of data may be accessed by the data requester; and
generate a response to the query.

101. The system of claim 100, wherein the authorization management tool is further operable to store identifying information about the data requester in the managed system database.

102. The system of claim 100, wherein the authorization management tool is further operable to store a query result in the managed system database, the query result related to whether the response was generated.

103. The system of claim 99, further comprising a state change tool residing in the memory and executable by the processor, the state change tool operable to:
receive a state change of a user;
compare the state change to the second set of data protection rules and the user preferences stored in the data protection database;
determine whether the state change complies with the second set of data protection rules and the user preferences; and
update the managed system database with the state change.

104. A system for managing a plurality of data protection rules, comprising:
receiving and storing the data protection rules in a data protection database;
receiving and storing a first set of managed system information in a managed system database;
extracting meta data from the managed system database and storing the meta data in the data protection database, the meta data associated with the first set of managed system information;
receiving a second set of managed system information;
comparing, by utilizing the meta data, the data protection rules to the second set of managed system information to determine if the second set of managed system information complies with the data protection rules;
notifying a data owner of one or more results of the comparison; and
updating the managed system database with the second set of managed system information.

105. The system of claim 104, further comprising generating a report of the data protection rules.

106. The computerized method of claim 104, further comprising:
receiving a second set of data protection rules;
comparing the second set of data protection rules to the first set of data protection rules to determine an impact on existing information;
notifying a data owner of the impact; and
updating the data protection database with the second set of data protection rules.

107. The computerized method of claim 106, wherein the existing information is one or more corporate policies.

108. The computerized method of claim 107, further comprising receiving one or more revised corporate policies and updating the data protection database with the corporate policies.

109. The computerized method of claim 106, wherein the existing information is one or more user preferences associated with one or more of the second set of data protection rules.

110. The computerized method of claim 109, further comprising:
querying a user about the user preferences;
accepting the user preference; and
updating the data protection database with the user preferences.

111. The computerized method of claim 104, further comprising:
accepting a query from a data requester, the query related to a particular set of data;
accessing the managed system database to validate that a permission exists for the data requester;
accessing the data protection rules in the data protection database to validate that the particular set of data may be accessed by the data requester; and
generating a response to the query.

112. The computerized method of claim 111, further comprising storing identifying information about the data requester in the managed system database.

113. The computerized method of claim 111, further comprising storing a query result in the managed system database, the query result related to whether the response was generated.

114. The computerized method of claim 110, further comprising:
receiving a state change of a user;
comparing the state change to the second set of data protection rules and the user preferences stored in the data protection database;
determining whether the state change complies with the second set of data protection rules and the user preferences; and
updating the managed system database with the state change.

115. A system for managing a plurality of data protection rules, comprising:
a processor;
a data protection database coupled to the processor, the data protection database operable to receive and store the data protection rules, a plurality of corporate policies, a plurality of permissions generated by a data owner, and one or more states of an entity;
a managed system database coupled to the processor, the managed system database operable to receive and store managed system information;
a memory coupled to the processor;
an authorization management tool residing in the memory and executable by the processor, the authorization management tool operable to:
accept a query from a data requester, the query related to a particular set of data;
access the managed system database to validate that a permission exists for the data requester;
access the data protection rules and the corporate policies in the data protection database to validate that the particular set of data may be accessed by the data requester; and
generate a response to the query;
a user acceptance tool residing in the memory and executable by the processor, the user acceptance tool operable to:
query a user about a user preference with respect to one or more data protection rules stored in the data protection database;
accept the user preference; and
store the user preference in the data protection database;
an impact analysis tool residing in the memory and executable by the processor, the impact analysis tool operable to:
receive a new set of data protection rules;
compare the new set of data protection rules to the data protection rules to determine an impact on existing information;
notify a data owner of the impact; and
update the data protection database with the new set of data protection rules;
a state change tool residing in the memory and executable by the processor, the state change tool operable to:
receive a state change of an entity;
compare the state change to the data protection rules stored in the data protection database;
determine whether the state change complies with the data protection rules; and
update the managed system database with the state change; and
an audit and compliance tool residing in the memory and executable by the processor, the audit and compliance tool operable to:
extract meta data from the managed system database and store the meta data in the data protection database, the meta data associated with the managed system information;
receive the new set of data protection rules;
compare, by utilizing the meta data, the new set of data protection rules to the managed system information to determine if the managed system information complies with the new set of data protection rules;
notify the data owner of one or more results of the comparison; and
update the data protection database with the new set of data protection rules.
